(19) United States
(12) Patent Application Publication
(10) Pub. No.: US 2013/0283852 A1
(43) Pub. Date: Oct. 31, 2013

(54) METHOD AND SYSTEMS FOR CO2 SEPARATION

(71) Applicants: Nikolett Sipöcz, Munich (DE); Jassin Marcel Fritz, Munich (DE); Miguel Angel Gonzalez Salazar, Munich (DE); Rene du Cauze de Nazelle, Munich (DE); Roger Allen Shisler, Ballston Spa, NY (US); Vitali Victor Lissianski, Niskayuna, NY (US); Vittorio Michelassi, Munich (DE)

(72) Inventors: Nikolett Sipöcz, Munich (DE); Jassin Marcel Fritz, Munich (DE); Miguel Angel Gonzalez Salazar, Munich (DE); Rene du Cauze de Nazelle, Munich (DE); Roger Allen Shisler, Ballston Spa, NY (US); Vitali Victor Lissianski, Niskayuna, NY (US); Vittorio Michelassi, Munich (DE)

(73) Assignee: GENERAL ELECTRIC COMPANY, SCHENECTADY, NY (US)

(21) Appl. No.: 13/456,290

(22) Filed: Apr. 26, 2012

(51) Int. Cl. F25J 3/00; F02C 7/00

(52) U.S. Cl. 62/617; 60/39.5

(57) ABSTRACT

A method for separating carbon dioxide (CO₂) from a gas stream is provided. The method includes cooling the gas stream in a cooling stage to form a cooled gas stream and cooling the cooled gas stream in a converging-diverging nozzle to form one or both of solid CO₂ and liquid CO₂. The method further includes separating at least a portion of one or both of solid CO₂ and liquid CO₂ from the cooled gas stream in the converging-diverging nozzle to form a CO₂-rich stream and a CO₂-lean gas stream. The method further includes expanding the CO₂-lean gas stream in an expander downstream of the converging-diverging nozzle to form a cooled CO₂-lean gas stream and circulating at least a portion of the cooled CO₂-lean gas stream to the cooling stage for cooling the gas stream. Systems for separating carbon dioxide (CO₂) from a CO₂ stream are also provided.

### BACKGROUND

1. Technical Field

The present disclosure relates to methods and systems for carbon dioxide (CO₂) separation from a gas stream. More particularly, the present disclosure relates to methods and systems for solid CO₂ separation.

2. Discussion of Related Art

Power generating processes that are based on combustion of carbon containing fuel typically produce CO₂ as a byproduct. It may be desirable to capture or otherwise separate the CO₂ from the gas mixture to prevent the release of CO₂ into the environment and/or to utilize CO₂ in the power generation process or in other processes.

However, typical CO₂ capture processes, such as, for example, amine-based process may be energy intensive as well as capital intensive. Low temperature and/or high pressure processes may also be used for CO₂ separation, wherein the separation is achieved by de-sublimation of CO₂ to form solid CO₂. However, the systems and methods for freezing CO₂ to form solid CO₂ typically involve rotating turbines. Turbine-based separation systems may suffer from the operational challenge of solid CO₂ deposition on the turbine blades, thereby resulting in erosion or malfunctioning of the turbine. Turbine-based CO₂ separation systems may further require additional separation systems (for example, cyclone separators), and may have reduced efficiencies because of frosting of surfaces of the system components. Furthermore, typical solid CO₂ separation systems include one or more pre-cooling steps, which require external refrigeration cycles that may increase the cost and footprint of the CO₂-separation systems.

Thus, there is a need for efficient and cost-effective methods and systems for separation of CO₂. Further, there is a need for efficient and cost-effective methods and systems for separation of solid CO₂.

### BRIEF DESCRIPTION

In one embodiment, a method for separating carbon dioxide (CO₂) from a gas stream is provided. The method includes cooling the gas stream in a cooling stage to form a cooled gas stream. The method further includes cooling the cooled gas stream in a converging-diverging nozzle such that a portion of CO₂ in the gas stream forms one or both of solid CO₂ and liquid CO₂. The method further includes separating at least a portion of one or both of solid CO₂ and liquid CO₂ from the cooled gas stream in the converging-diverging nozzle to form a CO₂-rich stream and a CO₂-lean gas stream. The method further includes expanding the CO₂-lean gas stream in an expander downstream of the converging-diverging nozzle to form a cooled CO₂-lean gas stream. The method further includes circulating at least a portion of the cooled CO₂-lean gas stream to the cooling stage for cooling the gas stream.

In another embodiment, a system for separating CO₂ from a gas stream is provided. The system includes a cooling stage configured to cool the gas stream to form a cooled gas stream. The system further includes a converging-diverging nozzle in fluid communication with the heat exchanger, wherein the converging diverging nozzle is configured to further cool the cooled gas stream such that a portion of CO₂ in the gas stream forms one or both of solid CO₂ and liquid CO₂, and wherein the converging diverging nozzle is further configured to separate at least a portion of one or both of solid CO₂ and liquid CO₂ from the cooled gas stream to form a CO₂-rich stream and a CO₂-lean gas stream. The system further includes an expander located downstream of the converging-diverging nozzle and in fluid communication with the converging-diverging nozzle, wherein the expander is configured to expand the CO₂-lean gas stream to form a cooled CO₂-lean gas stream. The system further includes a circulation loop configured to transfer the cooled CO₂-lean gas stream to the cooling stage for cooling the gas stream.

In yet another embodiment, a power-generating system is provided. The power generating system includes a gas engine assembly configured to generate a gas stream including CO₂; and a CO₂ separation unit in fluid communication with the gas engine assembly. The CO₂ separation unit includes a cooling stage configured to cool the gas stream to form a cooled gas stream. The CO₂ separation unit further includes a converging-diverging nozzle in fluid communication with the cooling stage, wherein the converging diverging nozzle is configured to further cool the cooled gas stream such that a portion of CO₂ in the gas stream forms one or both of solid CO₂ and liquid CO₂, and wherein the converging diverging nozzle is further configured to separate at least a portion of one or both of solid CO₂ and liquid CO₂ from the cooled gas stream to form a CO₂-rich stream and a CO₂-lean gas stream. The CO₂ separation unit further includes an expander located downstream of the converging-diverging nozzle and in fluid communication with the converging-diverging nozzle, wherein the expander is configured to expand the CO₂-lean gas stream to form a cooled CO₂-lean gas stream. The CO₂ separation unit further includes a circulation loop configured to transfer the cooled CO₂-lean gas stream to the cooling stage for cooling the gas stream.

Other embodiments, aspects, features, and advantages of the invention will become apparent to those of ordinary skill in the art from the following detailed description, the accompanying drawings, and the appended claims.

### BRIEF DESCRIPTION OF THE DRAWING FIGURES

These and other features, aspects, and advantages of the present invention will become better understood when the following detailed description is read with reference to the accompanying drawings in which like characters represent like parts throughout the drawings, wherein:

FIG. 1 is a block diagram of a system for CO₂ separation from a gas stream, in accordance with one embodiment of the invention.

FIG. 2 is a block diagram of a system for CO₂ separation from a gas stream, in accordance with one embodiment of the invention.

FIG. 3 is a block diagram of a system for CO₂ separation from a gas stream, in accordance with one embodiment of the invention.

FIG. 4 is a block diagram of a system for CO₂ separation from a gas stream, in accordance with one embodiment of the invention.

FIG. 5 is a block diagram of a power generating system including a CO₂-separation unit, in accordance with one embodiment of the invention.

FIG. 6 is a schematic of a converging-diverging nozzle, in accordance with one embodiment of the invention.

### DETAILED DESCRIPTION

As discussed in detail below, embodiments of the present invention include methods and systems suitable for CO₂ separation from a gas stream. As discussed in detail below, some embodiments of the present invention include methods and systems for CO₂ separation using a converging-diverging nozzle capable of cooling the gas stream to form liquid CO₂ or solid CO₂. The converging-diverging nozzle is further capable of separating at least a portion of the liquid CO₂ or the solid CO₂ in the converging-diverging nozzle itself, thereby generating a cooled CO₂-lean gas stream. Embodiments of the present invention further include methods and systems for CO₂ separation using the recycled cooled CO₂-lean gas stream for pre-cooling of the gas stream before providing the gas stream to the converging-diverging nozzle. In some embodiments, the methods and systems of the present invention advantageously provide for cost-effective and robust methods and systems for CO₂ separation when compared to expander-based CO₂ separation systems.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

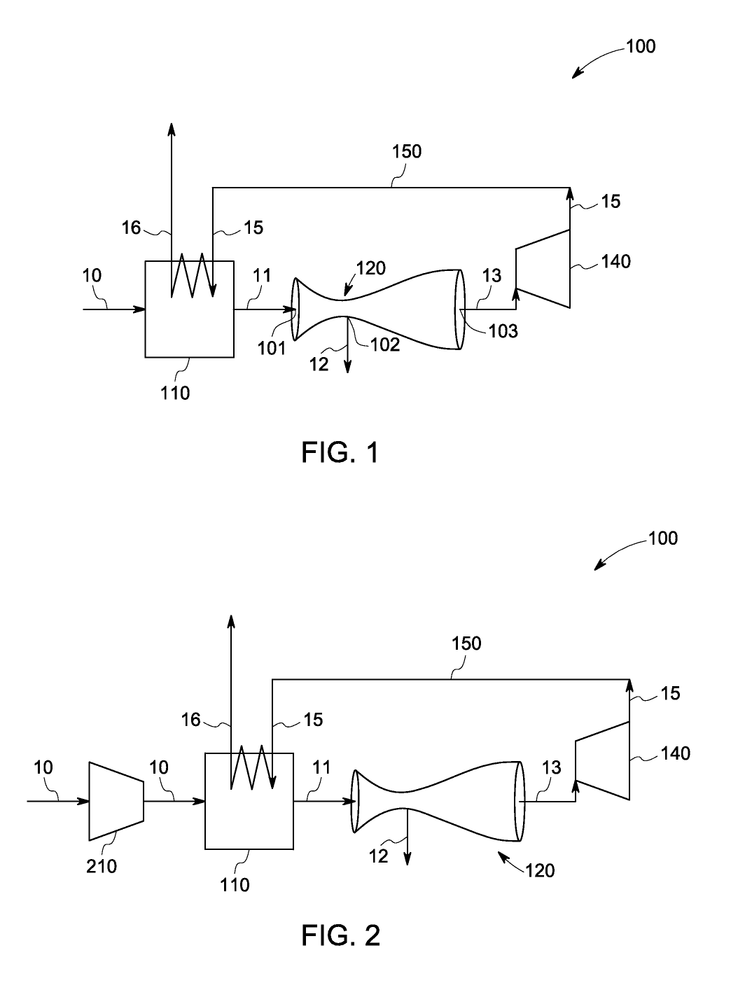

In some embodiments, as shown in FIGS. 1-5, a method for separating carbon dioxide (CO₂) from a gas stream 10 is provided. The term “gas stream” as used herein refers to a gas mixture, which may further include one or both of solid and liquid components. In some embodiments, the gas stream 10 is a product from a combustion process, a gasification process, a landfill, a furnace, a steam generator, a boiler, or combinations thereof. In one embodiment, the gas stream 10 includes a gas mixture emitted as a result of the processing of fuels, such as, natural gas, biomass, gasoline, diesel fuel, coal, oil shale, fuel oil, tar sands, or combinations thereof. In some embodiments, the gas stream 10 includes a gas mixture emitted from a gas turbine. In some embodiments, the gas stream 10 includes syngas generated by gasification or a reforming plant. In some embodiments, the gas stream 10 includes a flue gas. In particular embodiments, the gas stream 10 includes a gas mixture emitted from a coal or natural gas-fired power plant. As described in detail later, in some embodiments, the gas stream 10 includes a gas mixture emitted from a gas engine, such as, for example, internal combustion engine.

As noted earlier, the gas stream 10 includes carbon dioxide. In some embodiments, the gas stream 10 further includes one or more of nitrogen, oxygen, or water vapor. In some embodiments, the gas stream 10 further includes impurities or pollutants, examples of which include, but are not limited to, nitrogen oxides, sulfur oxides, carbon monoxide, hydrogen sulfide, unburnt hydrocarbons, particulate matter, and combinations thereof. In some embodiments, the gas stream 10 is substantially free of the impurities or pollutants. In some embodiments, the gas stream 10 includes nitrogen, oxygen, and carbon dioxide. In some embodiments, the gas stream 10 includes nitrogen and carbon dioxide. In some embodiments, the gas stream 10 includes carbon monoxide. In some embodiments, the gas stream 10 includes syngas.

In some embodiments, the amount of impurities or pollutants in the gas stream 10 is less than about 50 mole percent. In some embodiments, the amount of impurities or pollutants in the gas stream 10 is in a range from about 10 mole percent to about 20 mole percent. In some embodiments, the amount of impurities or pollutants in the gas stream 10 is less than about 5 mole percent.

In some embodiments, the method may further include compressing the gas stream 10 in a compressor 210 prior to the step of cooling the gas stream in the cooling stage 110, as indicated in FIG. 2. In some other embodiments, the method does not include the step of compressing the gas stream in a compressor 210 prior to the step of cooling the gas stream in the cooling stage 110, as indicated in FIG. 1. In some embodiments, the gas stream 10 may be in a pressurized state and may not require the additional step of compressing the gas stream before the cooling and CO₂ separation steps, which may enable lower capital costs and smaller number of system components.

In some embodiments, as indicated in FIG. 1, the method includes cooling the gas stream 10 in a cooling stage 110 to form a cooled gas stream 11. In some embodiments, the method may further include receiving a gas stream 10, from a hydrocarbon processing, combustion, gasification or a similar power plant (not shown), at the cooling stage 110. In some embodiments, the gas stream 10 may be further subjected to one or more processing steps (for example, removing water vapor, impurities, and the like) before providing the gas stream 10 to the cooling stage 110.

As indicated in FIG. 1, the cooling stage 110 may include a heat exchanger 110, in some embodiments. In some embodiments, the heat exchanger may be cooled using a cooling medium. In some embodiments, the heat exchanger may be cooled using the circulated cooled CO₂-lean gas stream 15, as described in detail below. In some embodiments, the heat exchanger may be cooled in part using the circulated cooled CO₂-lean gas stream 15 and may optionally be further cooled using cooling air, cooling water, or both (not shown). In particular embodiments, the gas stream 10 is primarily cooled in the heat exchanger by the circulated cooled CO₂-lean gas stream 15, as indicated in FIG. 1. The term “primarily cooled” as used herein means that at least about 80 percent of heat exchange in the cooling stage is effected using the circulated cooled CO₂-lean gas stream 15.

It should be noted that in FIG. 1, a single heat exchanger is shown as an exemplary embodiment only and the cooling stage 110 may be configured to include two or more heat exchangers in some embodiments. The actual number of heat exchangers and their individual configuration may vary depending on the end result desired. Further, in embodiments including a plurality of heat exchangers, at least one of the heat exchanger may be configured to cool the gas stream 10 using the circulated cooled CO₂-lean gas stream 15. In some embodiments, the method may include cooling the gas stream 10 in a plurality of heat exchangers, wherein the cooling is primarily effected using the circulated cooled CO₂-lean gas stream. In some embodiments, the method may include cooling the gas stream 10 in a plurality of cooling stages 110 (not shown) to form the cooled gas stream 11.

In some embodiments, as indicated in FIG. 1, the method further includes cooling the cooled gas stream 11 in a converging-diverging nozzle 120. As indicated in FIG. 1, in some embodiments, the method further includes transferring the cooled gas stream 11 from the cooling stage 110 to the converging-diverging nozzle 120. The term “converging-diverging nozzle” as used herein refers to a nozzle having converging and diverging regions, wherein the nozzle is configured to accelerate the gas stream to subsonic or supersonic velocities. As indicated, in FIG. 1, the converging-diverging nozzle 120 is located downstream of the cooling stage 110, in some embodiments. The terms “converging-diverging nozzle” and “nozzle” are used herein interchangeably.

In some embodiments, a temperature of the cooled gas stream 11 at the inlet 101 of the converging-diverging nozzle 120 is about 5 degrees Celsius below the CO₂ saturation temperature. In some embodiments, a pressure of the cooled gas stream at the inlet 101 of the converging-diverging nozzle 120 is in a range from about 4 bar to about 8 bar.

In some embodiments, the method includes further cooling (as described in detail later) the cooled gas stream 11 in the converging-diverging nozzle 120 such that a portion of CO₂ in the cooled gas stream 11 forms one or both of solid CO₂ and liquid CO₂.

In some embodiments, the converging-diverging nozzle 120 is configured to increase the velocity of the cooled gas stream 11 in the nozzle. Without being bound by any theory it is believed that by increasing the velocity of the cooled gas stream 11 in the converging diverging nozzle a static temperature decrease may be effected that enables the formation of solid CO₂ in the nozzle. In some embodiments, the converging-diverging nozzle 120 is configured to increase the velocity of the cooled gas stream 11 in the nozzle 120 to velocities such that a sufficient static temperature decrease is effected to result in formation of solid CO₂. The velocities of cooled gas stream 11 in the nozzle 120 may be determined by one or more of nozzle design, inlet gas temperature, inlet gas pressure, and the CO₂ content in the gas stream, as will be appreciated by one of ordinary skilled in the art.

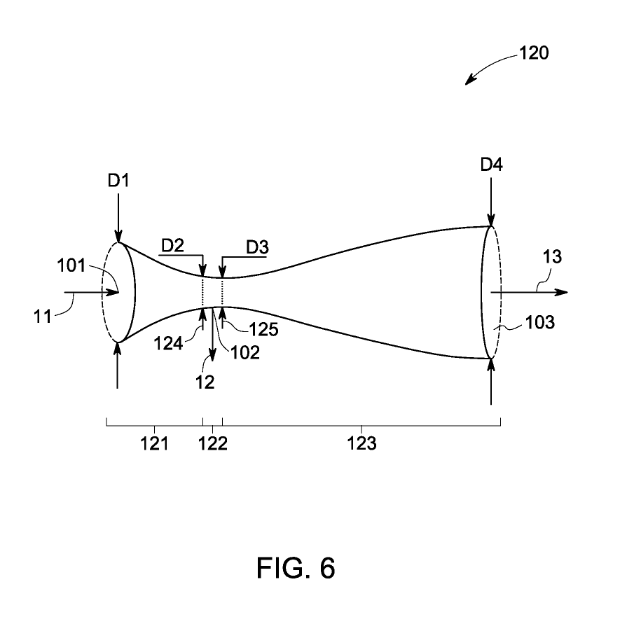

A representative converging-diverging nozzle, in accordance with some embodiments of the invention is illustrated in FIG. 6. In some embodiments, the converging-diverging nozzle 120, as indicated in FIG. 6, includes a converging section 121, a throat section 122, and a diverging section 123. In some embodiments, the converging-diverging nozzle 120 further includes an inlet 101, a first outlet 102 and a second outlet 103. As indicated in FIG. 6, the cooled gas stream 11 enters the converging section 121 of the nozzle 120 via the inlet 101. The converging region 121 is further defined by a diameter D1 at the inlet 101, as indicated in FIG. 6. As indicated in FIG. 6, the flow of the cooled gas stream 11 is directed to the throat section 122 of the nozzle 120 such that the diameter D1 from the inlet 101 of the converging section 121 continuously decreases to D2. The term D2 herein refers to the diameter of a first region 124 of the throat 122.

Without being bound by any theory, it is believed that a reduction in the diameter of the nozzle from D1 to D2 increases the kinetic energy of the cooled gas stream 11 such that that a corresponding reduction in static temperature occurs. In some embodiments, the diameter D2 is chosen such that the cooled gas stream 11 is accelerated to subsonic velocities resulting in a static temperature decrease in a range from about 20 Kelvin to about 70 Kelvin, depending on the nozzle design. In some embodiments, a static temperature decrease is in a range from about 20 Kelvin to about 50 Kelvin. In some embodiments, the static temperature of the cooled gas stream 11 in the region 124 falls below the saturation temperature of the CO₂, resulting in formation of solid CO₂ or liquid CO₂.

However, in some embodiments, the release of latent heat of fusion during the CO₂ solidification step may result in temperature increase of the gas flow, which may limit the formation of solid CO₂ or liquid CO₂. In some embodiments, the throat region 122 may further include a second region 125, such that a diameter D3 of the second region 125 in the throat region 122 is smaller than D2, as indicated in FIG. 6. Without being bound by any theory, it is believed that by directing the gas flow through a second region 125 having a diameter D3 that is smaller than D2, the additional energy generated because of release of latent heat of fusion may be converted to kinetic energy.

In some embodiments, the method further includes separating at least a portion of one or both of solid CO₂ and liquid CO₂ formed in the converging-diverging nozzle 120 from the cooled gas stream 11 to form a CO₂-rich stream 12. The term “CO₂-rich stream” as used herein refers to a stream including one or both of liquid CO₂ and solid CO₂, and having a CO₂ content greater than the CO₂ content of gas stream 10. It should be noted that the term “CO₂-rich stream” includes embodiments wherein the CO₂-rich stream may include one or more carrier gases. In some embodiments, the CO₂-rich stream is substantially comprised of CO₂. The term “substantially comprised of” as used herein means that the CO₂-rich stream includes at least about 90 mass percent of CO₂. In some embodiments, the CO₂-rich stream is primarily comprised of liquid CO₂. The term “primarily comprised of liquid CO₂” as used herein means that the amount of solid CO₂ is less than about 2 mass percent. In some embodiments, the CO₂-rich stream is primarily comprised of solid CO₂. The term “primarily comprised of solid CO₂” as used herein means that the amount of liquid CO₂ is less than about 2 mass percent. In some embodiments, one or both of solid CO₂ and liquid CO₂ may be separated from the gas stream in the nozzle because of the swirl generated by the high velocity stream within the nozzle 120 resulting in centrifugal separation.

In some embodiments, the method includes separating at least about 90 mass percent of CO₂ in the cooled gas stream 11 to form the CO₂-rich stream 12. In some embodiments, the method includes separating at least about 95 mass percent of CO₂ in the cooled gas stream 11 to form the CO₂-rich stream 12. In some embodiments, the method includes separating at least about 99 mass percent of CO₂ in the cooled gas stream 11 to form the CO₂-rich stream 12. In some embodiments, the method includes separating CO₂ in a range from about 50 mass percent to about 90 mass percent in the cooled gas stream 11 to form the CO₂-rich stream 12.

In some other embodiments, the CO₂-rich stream may further include one or more carrier gases to transport the liquid CO₂ or solid CO₂ to the first outlet 102 by centrifugal force. In some embodiments, the CO₂-rich stream may further include one or more nitrogen gas, oxygen gas, or carbon dioxide gas. In some embodiments, the amount of CO₂ in the CO₂-rich stream is at least about 50 mass percent of the CO₂-rich stream. In some embodiments, the amount of CO₂ in the CO₂-rich stream is at least about 60 mass percent of the CO₂-rich stream. In some embodiments, the amount of CO₂ in the CO₂-rich stream is at least about 75 mass percent of the CO₂-rich stream.

In some embodiments, the CO₂-rich stream is discharged from the converging-diverging nozzle via the first outlet 102, as indicated in FIGS. 1 and 6. It should be noted that the position of the first outlet 102 may vary, and FIGS. 1 and 6 illustrate representative embodiments only.

In some embodiments, the method further includes forming a CO₂-lean stream 13 in the converging diverging nozzle 120, as indicated in FIG. 1. The term “CO₂-lean stream” as used herein refers to a stream in which the CO₂ content is lower than that of the CO₂ content in the gas stream 10. In some embodiments, as noted earlier, almost all of the CO₂ in the cooled gas stream 11 is separated in the form of liquid CO₂ or solid CO₂ in the nozzle 120. In such embodiments, the CO₂-lean stream 13 is substantially free of CO₂. In some other embodiments, a portion of the liquid CO₂ or solid CO₂ may not be separated in the nozzle 120 and the CO₂ lean stream 13 may include CO₂ that is not separated.

In some embodiments, the CO₂-lean stream 13 may include one or more non-condensable components. In some embodiments, the CO₂-lean stream 13 may include one or more liquid components. In some embodiments, the CO₂-lean stream 13 may include one or more solid components. In such embodiments, the CO₂-lean stream 13 may be further configured to be in fluid communication with one or both of a liquid-gas and a solid-gas separator (not shown). In some embodiments, the CO₂-lean stream 13 may include one or more of nitrogen, oxygen, or sulfur dioxide. In some embodiments, the CO₂-lean stream 13 may further include carbon dioxide. In some embodiments, the CO₂-lean stream 13 may include gaseous CO₂, liquid CO₂, solid CO₂, or combinations thereof.

In particular embodiments, the CO₂ lean stream is substantially free of CO₂. The term “substantially free” as used in this context means that the amount of CO₂ in the CO₂-lean stream 13 is less than about 10 mass percent of the CO₂ in the gas stream 10. In some embodiments, the amount of CO₂ in the CO₂-lean stream 13 is less than about 5 mass percent of the CO₂ in the gas stream 10. In some embodiments, the amount of CO₂ in the CO₂-lean stream 13 is less than about 1 mass percent of the CO₂ in the gas stream 10.

In some embodiments, as illustrated in FIG. 6, the CO₂-lean stream is expanded in the diverging section 123 of the nozzle 120, wherein the diameter increases from D3 to D4. As indicated in FIGS. 1 and 6, the nozzle 120 further includes a second outlet 103. In some embodiments, the method includes discharging the CO₂-lean stream from the nozzle 120 via the second outlet 103.

As noted earlier, in some embodiments, the nozzle 120 is configured to increase the velocity of the cooled gas stream 11 in the nozzle to supersonic velocities. The term “supersonic” as used herein refers to velocity greater than Mach 1. In such embodiments, the method includes accelerating the cooled gas stream 11 in the converging section 121 to supersonic velocities. The method further includes separating the CO₂-rich stream 12 and discharge of high velocity CO₂-lean stream 13 in the diverging section 123. In such embodiments, the nozzle 120 may be configured to operate under supersonic conditions.

In some other embodiments, the converging-diverging nozzle 120 is configured to increase the velocity of the cooled gas stream 11 in the nozzle to subsonic velocities. The term “subsonic” as used herein refers to a velocity less than Mach 1. In such embodiments, the method includes accelerating the cooled gas stream 11 in the converging section 121 to subsonic velocities. The method further includes separating the CO₂-rich stream 12 and discharge of CO₂-lean stream 13 in the diverging section 123. In such embodiments, the diverging section 13 may function as a diffuser such that the CO₂-lean stream 13 exits the nozzle 120 at lower velocities than the velocity at that which it exits the nozzle 120. In such embodiments, the nozzle 120 may be configured to operate under subsonic conditions.

Without being bound by any theory it is believed, that operation of the nozzle under subsonic conditions when compared to supersonic conditions may advantageously provide for lower velocity flow, lower nozzle surface erosion, reduced instabilities from shock waves, and reduced total pressure loss.

In some embodiments, the method further includes expanding the CO₂-lean gas stream 13 in an expander 140 downstream of the converging-diverging nozzle 120 to form a cooled CO₂-lean gas stream 15, as indicated in FIG. 1. The term “expander” as used herein refers to a radial, axial, or mixed flow turbo-machine through which a gas or gas mixture is expanded to produce work.

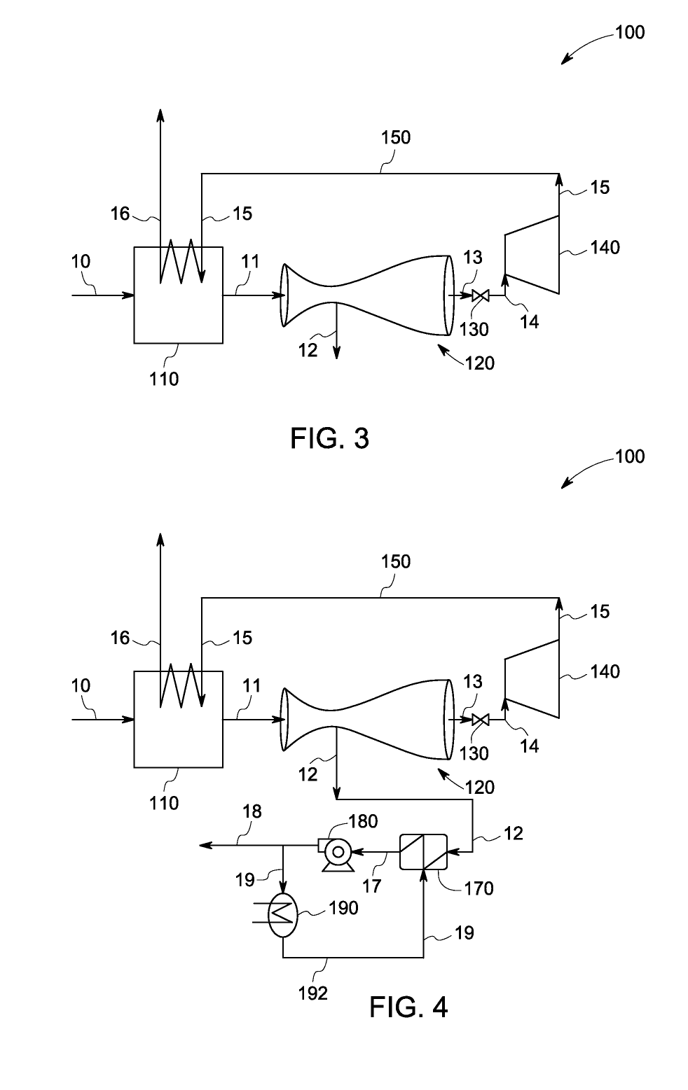

In some embodiments, the CO₂-lean gas stream 13 may be further pre-cooled using a valve 130 to form a pre-cooled CO₂ lean gas stream 14, before the expansion step in the expander 140, as indicated in FIG. 3. In such embodiments, the method may include the transferring the pre-cooled CO₂-lean gas stream 14 to the expander 140. In some embodiments, the valve may be used to reduce the pressure of the CO₂-lean stream 13 before the expansion step, such that the temperature at the outlet of the expander 140 may be controlled to preclude solidification of any residual CO₂ in the CO₂-lean stream 13. Suitable example of a valve 130, in accordance with some embodiments of the invention, includes a Joule-Thompson valve.

In some embodiments, the methods and systems in accordance with some embodiments of the invention allow for use of cost-effective expansion device, such as, the converging diverging nozzle, enabling reduced capital costs and operational risks when compared to turbo-expanders typically used for CO₂ solidification and separation.

In some embodiments, as indicated in FIG. 1, the method further includes circulating via a circulation loop 150 at least a portion of the cooled CO₂-lean gas stream 15 to the cooling stage 110. As discussed earlier, in some embodiments, the gas stream 10 is primarily cooled in the cooling stage 110 by the circulated cooled CO₂-lean gas stream 15. In some embodiments, the method further includes forming a secondary CO₂-lean gas stream 16 in the cooling stage 110 after the step of heat exchange with the gas stream 10, as indicated in FIG. 1.

In some embodiments, as noted earlier, cooling of the gas stream 10 in the cooling stage 110 may be primarily effected by the circulated cooled CO₂-lean gas stream 15. In some embodiments, the methods of the present invention advantageously provide for cost-effective methods for CO₂ separation by precluding the need for external refrigeration cycles, thus enabling lower power consumption and simpler separation systems (fewer components).

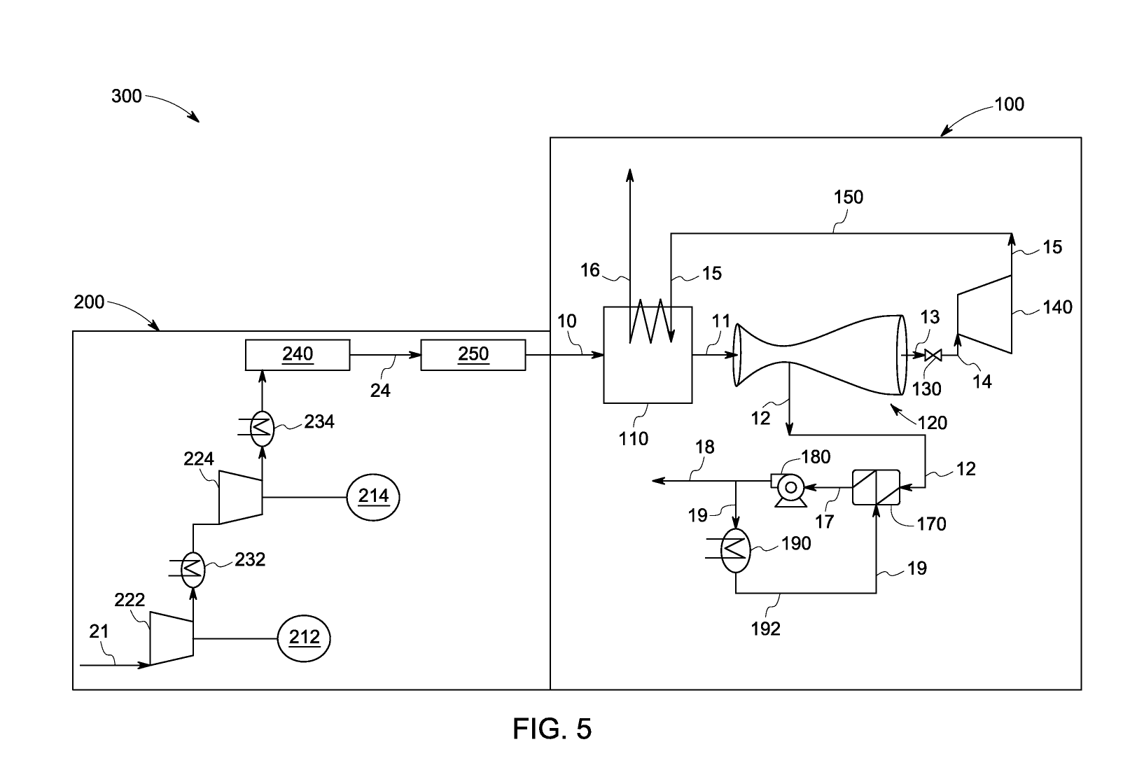

In some embodiments, the method includes cooling the cooled gas stream 11 in the converging-diverging nozzle 120 to primarily form solid CO₂ and separating the solid CO₂ from the cooled gas stream 11 to form a solid CO₂-rich stream 12. The term “solid CO₂-rich stream” as used herein refers to a stream including at least about 90 mass percent of solid CO₂. In some embodiments, the method further includes collecting the solid CO₂-rich stream via a cyclonic separator (not shown). In some embodiments, the method further includes transferring at least a portion of the solid CO₂-rich stream 12 to a liquefaction unit 170, as indicated in FIG. 4.

In some embodiments, the liquefaction unit 170 is configured to receive a pressurized gaseous CO₂ stream 19 and the solid CO₂-rich stream 12. In some embodiments, the pressurized gaseous CO₂ stream 19 is provided to the liquefaction unit 170 such that the equilibrium pressure of the stream is above the triple point of CO₂ and the equilibrium temperature of the stream is slightly lower than the triple point of CO₂, resulting in formation of a liquid from the gas/solid mixture. Suitable example of a liquefaction unit 170 includes a lock hopper system.

In some embodiments, the method includes liquefying at least a portion of the solid CO₂-rich stream 12 to form a liquid CO₂ stream 17 in the liquefaction unit 170. In some embodiments, the method further includes pressurizing at least a portion of the liquid CO₂ stream 17 in a pressurization unit 180 to form a pressurized liquid CO₂ stream 18. In some embodiments, the method further includes heating at least a portion of the pressurized liquid CO₂ stream 18 in a heating unit 190 to form a pressurized gaseous CO₂ stream 19. In some embodiments, the method further includes circulating at least a portion of the pressurized gaseous CO₂ stream 19 to the liquefaction unit 170.

In one embodiment, as indicated in FIGS. 1-5, a system 100 for separating carbon dioxide (CO₂) from a gas stream 10 is provided. The system 100 includes a cooling stage 110 configured to cool the gas stream 10 to form a cooled gas stream 11, as indicated in FIG. 1. The system 100 further includes a converging-diverging nozzle 120 in fluid communication with the cooling stage 110. The term “fluid communication” as used herein means that the components of the system are capable of receiving or transferring fluid between the components. The term fluid includes gases, liquids, or combinations thereof.

In some embodiments, the converging diverging nozzle 120 is configured to further cool the cooled gas stream 11 such that a portion of CO₂ in the cooled gas stream 11 forms one or both of solid CO₂ and liquid CO₂, as described in detail earlier. In some embodiments, the converging diverging nozzle is further configured to separate at least a portion of one or both of solid CO₂ and liquid CO₂ from the cooled gas stream 11 to form a CO₂-rich stream 12 and a CO₂-lean gas stream 13, as indicated in FIG. 1.

In some embodiments, the converging-diverging nozzle 120 is configured to accelerate the cooled gas stream 11 to supersonic velocities. In some embodiments, the converging-diverging nozzle 120 is configured to accelerate the cooled gas stream 11 to subsonic velocities. The terms supersonic and subsonic are defined earlier.

A representative converging-diverging nozzle, in accordance with some embodiments of the invention is illustrated in FIG. 6. In some embodiments, the converging-diverging nozzle 120, as indicated in FIG. 6, includes a converging section 121, a throat section 122, and a diverging section 123. In some embodiments, the converging-diverging nozzle 120 further includes an inlet 101, a first outlet 102 and a second outlet 103. In some embodiments, the inlet 101 is configured to receive the cooled gas stream 11, the first outlet 102 is configured to discharge the CO₂-rich stream 12, and the second outlet 103 is configured to discharge the CO₂-lean gas stream 13.

In some embodiments, the converging-diverging nozzle 120 is configured to substantially form solid CO₂ and to separate the solid CO₂ from the cooled gas stream 11 to form a solid CO₂-rich stream 12. In some embodiments, the system 100 may further include a cyclonic separator (not shown) to collect and transfer the solid-CO₂ rich stream 12.

In some embodiments, wherein the converging-diverging nozzle 120 primarily form solid CO₂, the system 100 may further include a liquefaction unit 170 in fluid communication with the converging-diverging nozzle 120, as indicated in FIG. 4. In some embodiments, the liquefaction unit 170 is configured to liquefy at least a portion of the solid CO₂-rich stream 12 to form a liquid CO₂ stream 17, as indicated in FIG. 4. The system 100 may further include a pressurization unit 180 and a heating unit 190 configured to form a pressurized liquid CO₂ stream 18 and a pressurized gaseous CO₂ stream 19, in some embodiments. In some embodiments, as indicated in FIG. 4, the system 100 may further include a circulation loop 192 configured to circulate at least a portion of the pressurized gaseous CO₂ stream 19 to the liquefaction unit 170. In some embodiments, the nozzle 120, in accordance with some embodiments of the invention, may preclude the need for a posimetric pump.

In some embodiments, the system 100 further includes an expander 140 located downstream of the converging-diverging nozzle 120 and in fluid communication with the converging-diverging nozzle 120. In some embodiments, the expander 140 is configured to expand the CO₂-lean gas stream 13 to form a cooled CO₂-lean gas stream 15, as indicated in FIG. 1. In some embodiments, the system 100 may further include a valve 130 located downstream of the converging-diverging nozzle 120 and upstream of the expander 140, as indicated in FIG. 3. In some embodiments, the valve 130 is in fluid communication with the converging-diverging nozzle 120. Suitable examples of a valve 130, in accordance with some embodiments of the invention, include a Joule-Thompson valve.

In some embodiments, the system 100 further includes a circulation loop 150 configured to transfer the cooled CO₂-lean gas stream 15 to the cooling stage 110 for cooling the gas stream 10, as indicated in FIG. 1.

In some embodiments, as indicated in FIG. 5, a power-generating system 300 is provided. In some embodiments, as indicated in FIG. 5, the power generating system 300 includes a gas engine assembly 200 configured to generate a gas stream 10 including CO₂. In some embodiments, the gas engine assembly 200 includes an internal combustion engine, such as, for example, a GE Jenbacher engine.

Referring again to FIG. 5, a representative power generating system 300, in accordance with some embodiments of the invention is illustrated. As will be appreciated by one of ordinary skilled in the art, the power generating system 300 may be suitable for use in a large-scale facility, such as a power plant for generating electricity that is distributed via a power grid to a city or town, or in a smaller-scale setting, such as part of a vehicle engine or small-scale power generation system. That is, the power generating system 300 may be suitable for a variety of applications and/or may be scaled over a range of sizes.

In the depicted example, in accordance with some embodiments of the invention, the power generating system 300 includes a gas engine assembly 200, wherein the gas engine assembly 200 does not include one or more turbo-expanders typically employed for turbo-expansion. Accordingly, the gas stream 10 discharged from the gas engine assembly 200, in such embodiments, may not require the additional step of compression before being provided to the CO₂ separation unit 120 as the gas stream 10 exiting the gas engine assembly 200 may already be in a compressed state.

In some embodiments, as indicated in FIG. 5, the gas engine assembly 200 includes interconnected turbo compressors 222 and 224 powered by synchronous motors 212 and 214 running at the same speed as the compressors. The gas engine assembly may further include one or more heat exchangers or intercoolers, 232 and 234, as indicated in FIG. 5. The gas engine assembly 200 further includes a gas engine 240 configured to combust air 21 and a fuel (not shown) to generate an exhaust gas stream 24. In some embodiments, the gas engine assembly 200 may optionally include a waste heat recovery unit 250, such as, for example, an organic Rankine cycle, configured to generate additional power from the exhaust gas stream 24 and generate the gas stream 10, which is further subjected to the CO₂ separation step as described in detail earlier.

In some embodiments, as indicated in FIG. 5, the power-generating system 300 further includes a CO₂ separation unit 100 in fluid communication with the gas engine assembly 200. In some embodiments, the CO₂ separation unit 100 is in fluid communication with a waste heat recovery unit 250, as indicated in FIG. 5. In some embodiments, the CO₂ separation unit 100 includes a cooling stage 110 configured to cool the gas stream 10 to form a cooled gas stream 11, as indicated in FIG. 5.

The CO₂ separation unit 100 further includes a converging-diverging nozzle 120 in fluid communication with the cooling stage 110. In some embodiments, the converging diverging nozzle 120 is configured to further cool the cooled gas stream 11 such that a portion of CO₂ in the cooled gas stream 11 forms one or both of solid CO₂ and liquid CO₂, as described in detail earlier. In some embodiments, the converging diverging nozzle 120 is further configured to separate at least a portion of one or both of solid CO₂ and liquid CO₂ from the cooled gas stream 11 to form a CO₂-rich stream 12 and a CO₂-lean gas stream 13, as indicated in FIG. 5.

In some embodiments, the converging-diverging nozzle 120 is configured to substantially form solid CO₂ and to separate the solid CO₂ from the cooled gas stream 11 to form a solid CO₂-rich stream 12. In some embodiments, the system 100 may further include a cyclonic separator (not shown) to collect and transfer the solid-CO₂ rich stream 12. In some embodiments, the CO₂-separation unit, in accordance with some embodiments of the invention, may preclude the need for a posimetric pump.

In some embodiments, the CO₂ separation unit 100 further includes an expander 140 located downstream of the converging-diverging nozzle 120 and in fluid communication with the converging-diverging nozzle 120. In some embodiments, the expander 140 is configured to expand the CO₂-lean gas stream 13 to form a cooled CO₂-lean gas stream 15, as indicated in FIG. 5. In some embodiments, the CO₂ separation unit 100 may further optionally include a valve 130 located downstream of the converging-diverging nozzle 120 and upstream of the expander 140, as indicated in FIG. 5. In some embodiments, the valve 130 may be in fluid communication with the converging-diverging nozzle 120. Suitable example of a valve 130, in accordance with some embodiments of the invention, includes a Joule-Thompson valve.

In some embodiments, the CO₂ separation unit 100 further includes a circulation loop 150 configured to transfer the cooled CO₂-lean gas stream 15 to the cooling stage 110 for cooling the gas stream 10, as indicated in FIG. 5.

In some embodiments wherein the converging-diverging nozzle primarily form solid CO₂, the CO₂ separation unit 100 may further include a liquefaction unit 170 in fluid communication with the converging-diverging nozzle 120, as indicated in FIG. 5. In some embodiments, the liquefaction unit 170 is configured to liquefy at least a portion of the solid CO₂-rich stream 12 to form a liquid CO₂ stream 17, as indicated in FIG. 5. The system 100 may further include a pressurization unit 180 and a heating unit 190 configured to form a pressurized liquid CO₂ stream 18 and a pressurized gaseous CO₂ stream 19, in some embodiments. In some embodiments, as indicated in FIG. 5, the system 100 may further include a circulation loop 192 configured to circulate at least a portion of the pressurized gaseous CO₂ stream 19 to the liquefaction unit 170.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for separating carbon dioxide (CO₂) from a gas stream, comprising:
(i) cooling the gas stream in a cooling stage to form a cooled gas stream;
(ii) cooling the cooled gas stream in a converging-diverging nozzle such that a portion of CO₂ in the gas stream forms one or both of solid CO₂ and liquid CO₂;
(iii) separating at least a portion of one or both of solid CO₂ and liquid CO₂ from the cooled gas stream in the converging-diverging nozzle to form a CO₂-rich stream and a CO₂-lean gas stream;
(iv) expanding the CO₂-lean gas stream in an expander downstream of the converging-diverging nozzle to form a cooled CO₂-lean gas stream; and
(v) circulating at least a portion of the cooled CO₂-lean gas stream to the cooling stage for cooling the gas stream.

2. The method of claim 1, wherein step (ii) comprises accelerating the cooled gas mixture in the converging-diverging nozzle to supersonic velocities.

3. The method of claim 1, wherein step (ii) comprises accelerating the cooled gas mixture in the converging-diverging nozzle to subsonic velocities.

4. The method of claim 1, wherein the gas stream is primarily cooled in the cooling stage by the circulated cooled CO₂-lean gas stream.

5. The method of claim 1, further comprising cooling the CO₂-lean gas stream using a valve before step (iv).

6. The method of claim 1, wherein the gas stream is subjected to a compression step before step (i).

7. The method of claim 1, wherein the gas stream is not subjected to a compression step before step (i).

8. The method of claim 1, wherein step (ii) comprises cooling the gas stream in the converging-diverging nozzle to primarily form solid CO₂ and step (iii) comprises separating the solid CO₂ from the cooled gas stream to form a solid CO₂-rich stream.

9. The method of claim 1, further comprising:
liquefying at least a portion of the solid CO₂-rich stream to form a liquid CO₂ stream in the liquefaction unit,
pressurizing at least a portion of the liquid CO₂ stream in a pressurization unit to form a pressurized liquid CO₂ stream,
heating at least a portion of the pressurized liquid stream to form a pressurized gaseous CO₂ stream, and
circulating at least a portion of the pressurized gaseous CO₂ stream to the liquefaction unit.

10. The method of claim 1, wherein at least about 50 mass percent of CO₂ present in the gas stream is separated in step (iii).

11. The method of claim 1, wherein the CO₂-lean gas stream is substantially free of CO₂.

12. A system for separating carbon dioxide (CO₂) from a gas stream, comprising:
(a) a cooling stage configured to cool the gas stream to form a cooled gas stream;
(b) a converging-diverging nozzle in fluid communication with the cooling stage, wherein the converging diverging nozzle is configured to further cool the cooled gas stream such that a portion of CO₂ in the gas stream forms one or both of solid CO₂ and liquid CO₂, and wherein the converging diverging nozzle is further configured to separate at least a portion of one or both of solid CO₂ and liquid CO₂ from the cooled gas stream to form a CO₂-rich stream and a CO₂-lean gas stream;
(c) an expander located downstream of the converging-diverging nozzle and in fluid communication with the converging-diverging nozzle, wherein the expander is configured to expand the CO₂-lean gas stream to form a cooled CO₂-lean gas stream; and
(d) a circulation loop configured to transfer the cooled CO₂-lean gas stream to the cooling stage for cooling the gas stream.

13. The system of claim 12, wherein the converging-diverging nozzle is configured to accelerate the gas stream to supersonic velocities.

14. The system of claim 12, wherein the converging-diverging nozzle is configured to accelerate the gas stream to subsonic velocities.

15. The system of claim 12, wherein the converging-diverging nozzle further comprises a first outlet for discharging the CO₂-rich stream and a second outlet for discharging the CO₂-lean gas stream.

16. The system of claim 12, further comprising a valve located downstream of the converging-diverging nozzle and upstream of the expander, wherein the valve is in fluid communication with the converging-diverging nozzle.

17. The system of claim 12, wherein the converging-diverging nozzle is configured to substantially form solid CO₂ and to separate the solid CO₂ from the cooled gas stream to form a solid CO₂-rich stream.

18. The system of claim 17, further comprising a liquefaction unit in fluid communication with the converging-diverging nozzle, wherein the liquefaction unit is configured to liquefy at least a portion of the solid CO₂-rich stream to form a liquid CO₂ stream.

19. The system of claim 18, further comprising:
a pressurization unit configured to form a pressurized liquid CO₂ stream,
a heating unit configured to form a pressurized gaseous CO₂ stream, and
a circulation unit configured to circulate at least a portion of the pressurized gaseous CO₂ stream to the liquefaction unit.

20. A power-generating system, comprising:
(A) a gas engine assembly configured to generate a gas stream comprising carbon dioxide (CO₂); and
(B) a CO₂ separation unit in fluid communication with the gas engine assembly, comprising:
(a) a cooling stage configured to cool the gas stream to form a cooled gas stream;
(b) a converging-diverging nozzle in fluid communication with the cooling stage, wherein the converging diverging nozzle is configured to further cool the cooled gas stream such that a portion of CO₂ in the gas stream forms one or both of solid CO₂ and liquid CO₂, and wherein the converging diverging nozzle is further configured to separate at least a portion of one or both of solid CO₂ and liquid CO₂ from the cooled gas stream to form a CO₂-rich stream and a CO₂-lean gas stream;
(c) an expander located downstream of the converging-diverging nozzle and in fluid communication with the converging-diverging nozzle, wherein the expander is configured to expand the CO₂-lean gas stream to form a cooled CO₂-lean gas stream; and
(d) a circulation loop configured to transfer the cooled CO₂-lean gas stream to the cooling stage for cooling the gas stream.
